(19) United States
(12) Patent Application Publication
(10) Pub. No.: US 2006/0048452 A1
(43) Pub. Date: Mar. 9, 2006

(54) Flexible mounting bracket for vehicle window panel

(76) Inventors: John A. Sweeney, Troy, MI (US); Kenneth Bond, Shelby Township, MI (US); Mark G. Mazurek, Shelby Township, MI (US)

Correspondence Address: PPG INDUSTRIES, INC.;INTELLECTUAL PROPERTY DEPT., ONE PPG PLACE, PITTSBURGH, PA, 15272, US

(21) Appl. No.: 10/934,156

(22) Filed: Sep. 3, 2004

(51) Int. Cl. E05F 15/16

(52) U.S. Cl. 49/374; 49/349

(57) ABSTRACT

A flexible mounting bracket for a vehicle window assembly includes a first mounting bracket portion configured to engage a vehicle window panel, a second mounting bracket portion configured to engage a window regulating assembly, and a third mounting bracket portion located between the first and second portions. The third portion can be flexible or can be configured such that the first portion is movable or bendable relative to the second portion.

### BACKGROUND OF THE INVENTION

1. Field of the Invention

This invention relates generally to mounting brackets for attaching a panel, such as a window panel, to a regulator system and, in one particular embodiment, to a mounting bracket for attaching a vehicle window panel to a window regulator mechanism in a vehicle door.

2. Technical Considerations

Modern automobiles typically include window assemblies having regulator systems to raise and lower the vehicle windows. In one type of conventional window assembly, the window panel is connected to a rigid, horizontal regulator bar by one or more rigid mounting brackets so that the window panel is securely attached to the regulator bar. When the regulator bar is raised and lowered, the window panel is also raised and lowered in a window track formed in the vehicle door. The structure and operation of conventional vehicle window assemblies will be well understood by one of ordinary skill in the art and, therefore, will not be discussed in detail herein.

However, one problem associated with conventional window assemblies involves connecting the window panel to the regulator system when the vehicle is being assembled or if the window panel requires replacement. For example, the window regulator system is typically installed in the vehicle door prior to connecting the window panel to the regulator system. The mounting brackets are connected to the window panel, such as by adhesives or bolts. The window panel/mounting bracket assembly is then connected to the regulator system, such as by bolting, bonding, snapping, or friction fitting the mounting brackets to the regulator bar. However, due to manufacturing variations, the regulator bar may not be exactly aligned with the window track of the vehicle or the regulator bar may not align exactly with the shape of the window. Therefore, it is not uncommon for the window panel to have to be twisted or torqued in order to attach the window panel to the regulator system or to align the window in the window track. This can cause the window panel to fail by cracking or other mechanisms or can cause undue stress on the window panel. Once attached, there can be a continual static load on the window panel due to misalignment of the window panel and/or of the door and/or of the regulator system relative to each other.

Additionally, many modern vehicles have electric lift motors connected to the regulator system to raise and lower the window panel automatically at the touch of a button. If the motor is misadjusted or the window track is not of proper dimensions, when the window is closed, the motor may continue to run for a short time and push the window panel upwardly against the top of the window track. This can also impose stress on the window panel. Moreover, if the window track itself is not perfectly aligned, the window panel can bind in the window track as the regulator assembly is raised and lowered.

These problems can be exacerbated by the use of laminated vehicle windows. Laminated vehicle windows, such as laminated sidelights, are desirable for providing improved solar control, sound reduction, and other performance-enhancing features compared to conventional single pane window panels. Laminated vehicle windows are typically formed by two relatively thin glass sheets connected by a polymeric interlayer. A solar control coating can also be provided, such as between the glass sheets. However, while providing desirable features, these laminated sidelights can be more susceptible to breaking or cracking than conventional single-pane window panels due to the relative thinness of the multiple glass sheets in the laminated sidelight. This is particularly the situation if the laminated window panel is twisted or torqued to connect the window panel to the regulator system, or if the window panel binds or jams in the window track, or if the lift motor pushes the window panel against the top of the window track, or if the window panel experiences a constant static torsional load due to the mounting points being misaligned.

Therefore, it would be desirable to provide a vehicle window mounting bracket and/or a vehicle window assembly that reduces or eliminates at least some of the problems described above.

### SUMMARY OF THE INVENTION

A flexible mounting bracket includes a first mounting bracket portion (engagement portion) configured to engage a panel, such as a window panel, a second mounting bracket portion (attachment portion) configured to engage a regulator system, such as an architectural or vehicle regulator system, and a third mounting bracket portion (linking portion) located between the first and second portions. The mounting bracket is configured such that the first and second portions are movable relative to each other. For example, the first portion can be movable, e.g., pivotable or bendable, relative to the second portion. That is, the mounting bracket is configured such that when the first portion is connected to the panel and the second portion is connected to the regulator system, the mounting bracket can bend, or flex, or pivot, or twist, or otherwise move such that misalignment, twisting, torquing, and similar forces acting on the panel are relieved. For example, the third portion can be flexible or bendable. Or, the mounting bracket can be configured in such a way that the positions of the first and/or second portions can be changed or moved with respect to each other without bending the third portion, such as by the first and/or second portions being connected by a rigid third portion comprising, for example, ball and socket connections or similar construction. This permits the window panel to be attached more easily to the regulator system, such as by bending, twisting, or flexing a portion of the mounting bracket rather than the window panel itself. This also permits the window panel to ride more easily in the window track and can permit the bracket, not the window panel, to absorb stress caused by misalignment of the electric lift motor or static stresses due to continual misalignment of the window panel and/or the window track and/or the regulator system. The “flexibility” of the bracket can be a function of the material of construction of the mounting bracket and/or the geometry of the mounting system of the type of linking portion used.

A window assembly includes a window panel, a regulator system configured to raise and lower the window panel, and at least one flexible mounting bracket configured to connect the window panel to the regulator system.

Another window assembly comprises a laminated window panel, a regulator system configured to raise and lower the window panel, and at least one flexible mounting bracket connecting the window panel to the regulator system. The flexible mounting bracket can comprise (a) a substantially rigid first portion comprising a base and at least one leg, for example a pair of spaced legs defining a substantially U-shaped channel, the first portion configured to engage the window panel, (b) a substantially rigid second portion having an engagement element configured to engage an attachment element of the regulator system to connect the bracket to the regulator system, and (c) a linking portion located between the first and second portions. The linking portion can be configured such that the first portion is non-frangibly movable relative to the second portion over a range of flexibility having a deflection angle in the range of up to±45°, such as up to±10°.

In another embodiment, the third or linking portion of the mounting bracket can be formed by a rigid link or series of links that provide the ability of the first portion and second portion to move independently of each other. For example, the first and/or second portions can be connected to the third portion by a ball and socket connection.

A method of attaching a vehicle window panel to a window regulator system includes attaching at least one flexible mounting bracket to a window panel and attaching the at least one mounting bracket to a vehicle regulator system by flexing, bending, pivoting, twisting, or generally moving the mounting bracket to align an engagement element on the bracket with an attachment element on the regulator system.

### BRIEF DESCRIPTION OF THE DRAWINGS

Additional advantages and details of the invention are described below with reference to the exemplary embodiments illustrated in the accompanying drawing figures, in which like reference numbers identify like parts throughout.

FIG. 1 is a side view (not to scale) of an exemplary window assembly incorporating features of the invention;

FIG. 2 is a perspective view (not to scale) of a flexible mounting bracket of the invention;

FIG. 3 is a perspective view (not to scale) of a further flexible mounting bracket of the invention;

FIG. 4 is a cross-sectional view (not to scale) of another flexible mounting bracket of the invention;

FIGS. 5-7 are additional embodiments of a flexible mounting bracket of the invention; and

FIGS. 8 and 9 illustrate the flexibility range of a flexible mounting bracket in accordance with the invention.

### DESCRIPTION OF THE PREFERRED EMBODIMENTS

As used herein, spatial or directional terms, such as “inner”, “outer”, “above”, “below”, “top”, “bottom”, “left”, “right”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.1, 3.5 to 7.8, 5.5 to 10, etc. All references referred to herein, such as but not limited to issued patents and published applications, are to be understood to be incorporated by reference in their entirety. By “flexible” mounting bracket is meant that at least one portion of the mounting bracket can move, e.g., bend, flex, pivot, twist, etc., with respect to another portion of the mounting bracket without breaking.

The general concepts of the invention will now be described with respect to mounting a window to a vehicle regulator system. However, it is to be understood that this is just one exemplary practice of the invention and that the invention is not limited to use with windows or with vehicle regulator systems. The invention can be used to mount or connect any panel to a movement system. For example, the invention could be utilized to connect an architectural panel to a regulator system.

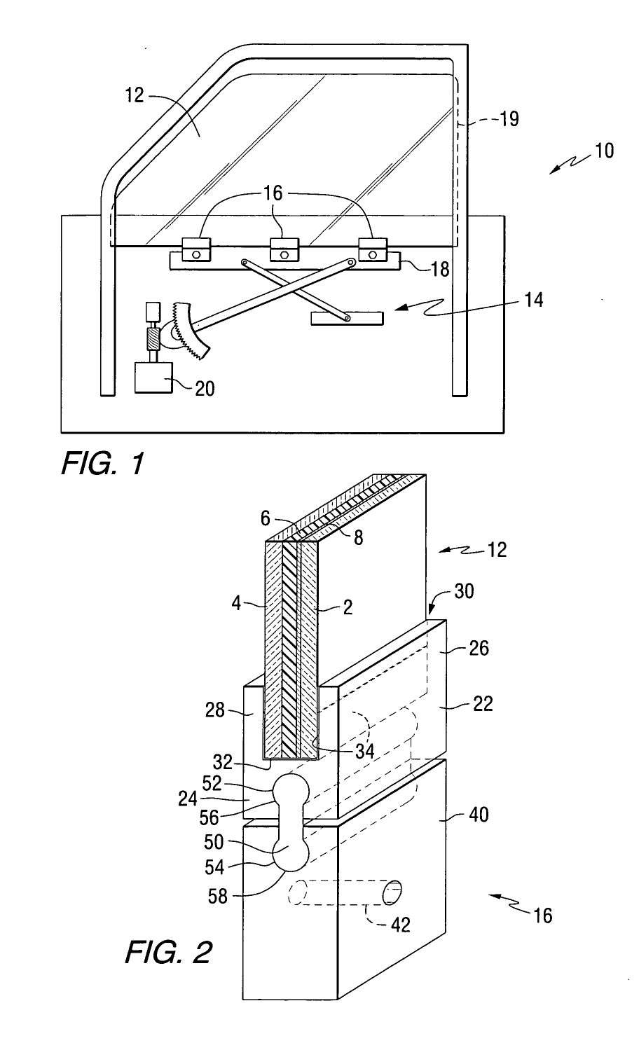

An exemplary movable panel assembly in the form of a window assembly 10 incorporating features of the invention is shown in FIG. 1. The window assembly 10 is depicted as being installed in a conventional vehicle door. However, it is to be understood that the invention is not limited to use with vehicle doors. The movable panel assembly, e.g., window assembly 10, includes a movable panel in the form of a window panel 12 that is connected to a regulator system 14 by one or more flexible mounting brackets 16 of the invention.

The window panel 12 can be a conventional monolithic, i.e., single pane, window. Alternatively, the window panel 12 can be a laminated window panel (see FIG. 2) having two or more sheets 2, 4 adhered by a polymeric interlayer 6. The sheets 2, 4 can be of any conventional material, such as but not limited to glass, or polymeric materials such as polycarbonates, or acrylics, just to name a few. The laminated window panel can include a solar control coating 8 deposited on one or more of the glass sheets 2, 4, such as on an inner surface of one of the glass sheets 2, 4. An exemplary laminated window panel useful for the practice of the invention is described in U.S. Pat. No. 6,582,799. The window panel 12 can be of any desired dimensions and of any desired shape.

The regulator system 14 is configured to move, e.g., raise and lower, the window panel 12 (movable panel) in a window track 19 of the vehicle. Any conventional regulator system can be used with the invention. The use and operation of conventional regulator systems will be well understood by one of ordinary skill in the art and, hence, will not be discussed in detail herein. The regulator system 14 illustrated in FIG. 1 includes a conventional scissors-type lift mechanism to raise and lower a regulator bar 18, such as by an electric lift motor 20. However, the invention is not limited to use with scissors-type regulator mechanisms but could be used with any type of regulator system, such as but not limited to regulator systems utilizing a flexible cable, a pivoting bar, a rack and pinion system, a roller cable assembly, or gears, just to name a few. Examples of conventional regulator systems are described in U.S. Pat. Nos. 6,145,252; 6,216,394; 6,560,929; 6,389,753; 5,685,596; and 6,425,207, and published applications US 2003/0140562 A1and US 2004/0049986 A1. Nor is the invention limited to use with straight regulator bars but could be practiced with any type of regulator mechanism, such as but not limited to arcuate or curved bars, or could be practiced with regulator systems that do not have regulator bars.

In one practice of the invention, the window panel 12 is connected to the regulator system 14 by one or more flexible mounting brackets 16 of the invention. In the embodiment of the invention shown in FIG. 2, the mounting bracket 16 includes a first or window engagement portion 22 configured to engage the window panel 12. In the broad practice of the invention, this engagement portion 22 can be of any conventional design. However, in the illustrated embodiment, the engagement portion 22 comprises a base 24 having a pair of spaced legs 26, 28 that define a generally U-shaped channel 30 for receipt of a lower edge 32 of the window panel 12. The window panel 12 can be connected to the mounting bracket 16 in any conventional manner, such as but not limited to mechanical means, such as bolts or screws, or chemical means, such as conventional adhesives. In the illustrated embodiment, the window panel 12 is connected to the mounting bracket 16 by an adhesive 34, such as but not limited to a conventional curable polyurethane adhesive. The engagement portion 22 can be made of a substantially rigid material so as to securely engage the window panel 12. By “substantially rigid” is meant that the material is not designed to bend or flex to any appreciable amount during normal operating procedures. For example, the engagement portion 22 can be formed from a relatively strong and rigid plastic, such as but not limited to glass filled polycarbonate or similarly hard, durable, or rigid material. An example of one suitable material is LEXAN material commercially available from General Electric Company Corporation.

The mounting bracket 16 further includes a second or attachment portion 40 configured to be attached to or connected to the regulator system 14 shown in FIG. 1. The attachment portion 40 can be attached to the regulator system 14 in any conventional manner, such as but not limited to adhesives, bolts, screws, clamps, or bayonet mounts, just to name a few. In the illustrated non-limiting embodiment, the attachment portion 40 includes an engagement element in the form of a bore 42 configured to receive a retaining member, such as a bolt, a stud, a rivet, or the like, to connect the mounting bracket 16 to the regulator system 14. However, any conventional type of engagement element, such as those described immediately above, could be used. The bore 42 in the mounting bracket 16 can be aligned with a bore in the regulator bar 18 such that the mounting bracket 16 can be securely connected to the regulator bar 18 by a retaining bolt. The attachment portion 40 can also be made of a substantially rigid material, such as a substantially rigid plastic as described above for the engagement portion 22.

The first (engagement) portion 22 of the mounting bracket 16 can be connected to the second (attachment) portion 40 of the mounting bracket 16 by a linking portion or linking member 50 such that the first portion 22 can move, e.g., flex, bend, or twist with respect to the second portion 40 over a range of flexibility without breaking. That is, the mounting bracket 16 is meant to be non-frangible over the range of flexibility, as described in more detail below. The linking member 50 can be made of or can comprise an elastic or deformable material capable of sustaining deformation without permanent loss of size or shape. Examples of suitable elastic materials include, but are not limited to, rubber, plastics, and the like. In the embodiment shown in FIG. 2, the first portion 22 and second portion 40 of the mounting bracket 16 have keyways 52, 54, respectively, configured to receive complementary-shaped portions 56, 58, respectively, of an elongated linking member 50 such that the linking member 50 attaches the rigid first portion 22 to the rigid second portion 40 but still permits the two portions to bend or flex with respect to each other. The first and second portions 22, 40 can bend or flex in a crosswise direction (i.e., to the left and right in FIG. 2) and can also flex in a longitudinal, direction (i.e., forwardly and rearwardly in FIG. 2). Moreover, the flexible linking member 50 can also provide rotational or torsional flexibility, e.g., along its longitudinal axis, to allow the first and second portions 22, 40 to twist or pivot with respect to each other along the longitudinal axis.

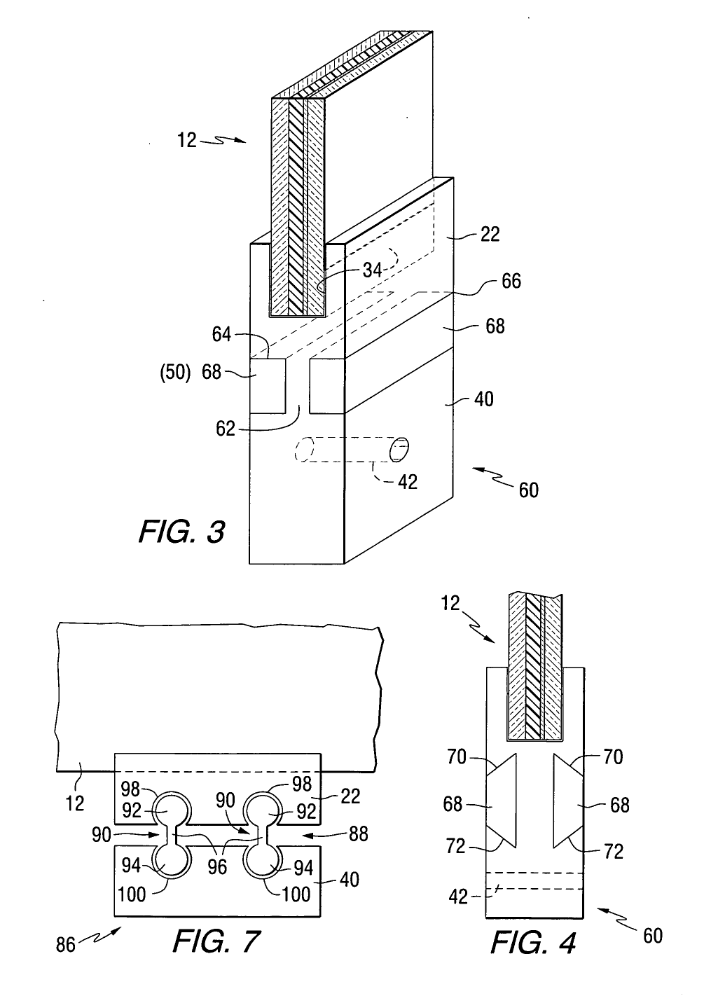

An alternative flexible mounting bracket 60 of the invention is shown in FIG. 3. In this embodiment, the first and second portions 22, 40 are connected by a linking member 50 in the form of a flexible member 62 that can be of the same or different material than the material of the first and second portions 22, 40. That is, the mounting bracket 60 can be a unitary piece, such as but not limited to a molded plastic piece. However, this flexible member 62 permits the first and second portions 22, 40 to bend or flex with respect to each other over a range of flexibility without breaking. The relatively thin, elongated, flexible member 62 positioned between the first and second portions 22, 40 defines two side channels 64, 66 on the sides of the mounting bracket 60. These side channels 64, 66 can be open to increase the range of flexibility of the mounting bracket 60. Alternatively, to add additional strength to the mounting bracket 60 without unduly impacting the range of flexibility, a second material 68, such as an elastic or polymeric material, can be deposited in the channels 64, 66 on the sides of the mounting bracket 60. The flexible member 62 permits the first and/or second portions 22, 40 to move, e.g., bend, flex, twist, with respect to the other portion over a range of flexibility without breaking.

FIG. 4 shows an alternative embodiment of the mounting bracket 60 of FIG. 3. In this embodiment, the top walls 70 and bottom walls 72 forming the side channels of the mounting bracket 60 are tapered to more securely hold the second material 68 in place.

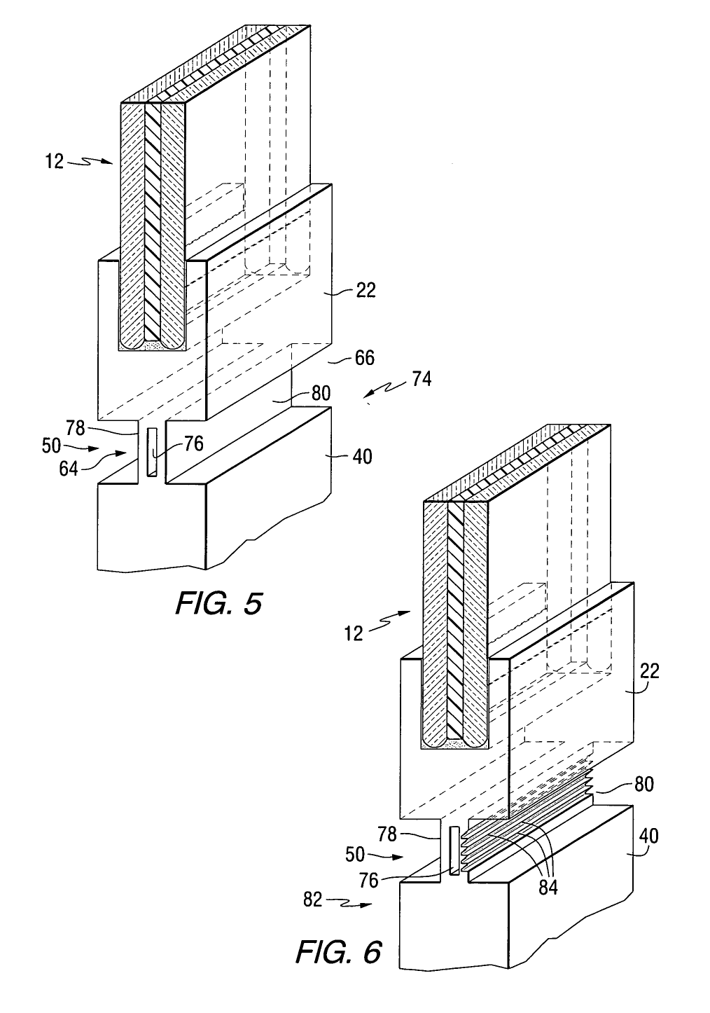

FIG. 5 shows another mounting bracket 74 incorporating features of the invention. The mounting bracket 74 is similar to the mounting bracket 60 described above and shown in FIG. 3 but the linking portion 50 includes a longitudinal slot 76 extending through or at least partly through the linking portion 50. In the illustrated embodiment, the slot 76 is depicted as rectangular in shape. However, it is to be understood that the slot 76 could be of any shape. The slot 76 defines spaced sidewalls 78, 80 in the linking portion 50. The slot 76 provides the linking portion 50 with increased freedom of movement, e.g., flexible, bendable, or torsional, over a solid linking portion 50 of the same material without the slot 76. As in the mounting bracket 60, elastic material can be provided in the slot 76 and/or the channels 64, 66 if desired.

FIG. 6 shows a further mounting bracket 82 similar to the mounting bracket 74. However, this mounting bracket 82 includes one or more longitudinal grooves 84 formed in one or both sidewalls 78, 80 to further increase the freedom of movement of the mounting bracket 82. Alternatively, the slot 76 may not be present and the groves 84 can be formed in one or both sides of the linking portion 50.

FIG. 7 shows a still further mounting bracket 86 of the invention. In this embodiment, the first and second portions 22, 40 are connected by a rigid linking portion 88. In one embodiment, the rigid linking portion 88 includes one or more ball connectors 90 that can be formed by spaced balls 92, 94 connected by a rigid pin 96. The balls 92, 94 engage sockets 98, 100 on the first and second portions 22, 40, respectively. Thus, the first and second portions 22, 40 can move, e.g., twist, bend, pivot, etc., with respect to each other on the ball connectors 90.

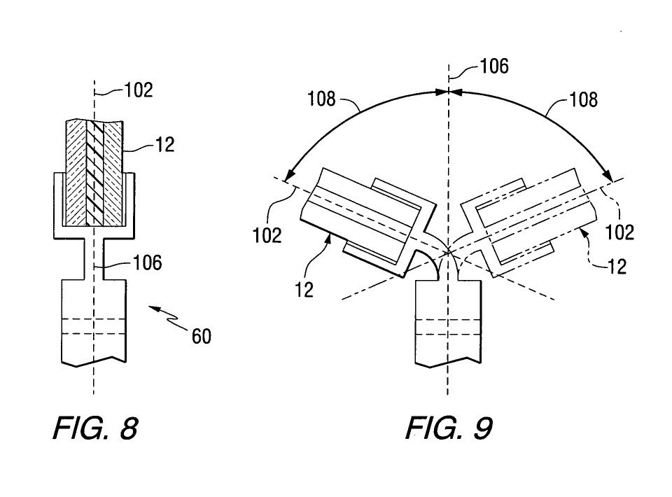

As will be appreciated from the above discussion, the mounting brackets of the invention provide a range of flexibility not found in conventional window mounting brackets. By “range of flexibility” is meant the angle or range over which one portion of the mounting bracket can bend or flex with respect to another portion of the mounting bracket from an original or non-bent position. FIG. 8 shows a mounting bracket 60 as described above in a first or non-bent position. A longitudinal axis 102 of the bottom portion of the window panel 12 is aligned with a longitudinal axis 106 of the mounting bracket 60. As shown in FIG. 9, the window panel 12 can be bent or flexed to the left (solid lines) or right (dashed lines). The longitudinal axis 102 of the bottom portion of the window panel 12 can thus be deflected to the left and/or right by a deflection angle 108 from the original longitudinal axis 106 of the mounting bracket 60. The “range of flexibility” of the mounting bracket 60 is defined by the maximum deflection angle 108 that the mounting bracket 60 can be bent or flexed with respect to the longitudinal axis 106 without damage or fracture of the mounting bracket 60. Moreover, the mounting brackets of the invention also provide torsional flexibility and longitudinal flexibility to the connection assembly.

In one non-limiting embodiment, the mounting bracket of the invention can have a range of flexibility with the maximum deflection angle having a value in the range of up to±45° from the longitudinal axis 106, such as up to±40°, such as up to±30°, such as up to±25°, such as up to±20°, such as up to±15°, such as up to±10°, such as up to±5°, such as up to±3°, such as up to±2°.

An exemplary use of a mounting bracket of the invention is as follows. Typically, the regulator system 14 is mounted in the vehicle door during fabrication of the vehicle. In one practice, the mounting brackets 60 can be attached to the window panel 12 at spaced intervals. To connect the window panel 12 to the regulator system 14 by using a flexible mounting bracket 60 of the invention, the mounting bracket 60 can be bent or flexed to align the engagement element of the mounting bracket 60 with the attachment element of the regulator system 14 without having to twist the window panel 12 by any significant amount. Additionally, should the window track of the door be misaligned, the torsional and longitudinal flexibility of the mounting bracket 60 of the invention permits the window panel to more easily ride in the window track without binding. Moreover, should the electric lift motor that raises and lowers the window panel 12 be misaligned and the motor continue to run after the top of the window panel 12 has engaged the top of the window track, the flexible mounting bracket 60 of the invention permits the bottom portion of the window panel 12 to kick outwardly, i.e., bend or pivot around the flexible portion of the mounting bracket, to relieve the stress on the window.

It will be readily appreciated by those skilled in the art that modifications may be made to the invention without departing from the concepts disclosed in the foregoing description. Accordingly, the particular embodiments described in detail herein are illustrative only and are hot limiting to the scope of the invention, which is to be given the full breadth of the appended claims and any and all equivalents thereof.

What is claimed is:

1. A flexible mounting bracket for a vehicle window assembly, comprising:
a first mounting bracket portion configured to engage a vehicle window panel;
a second mounting bracket portion configured to attach to a window regulator system; and
a third mounting bracket portion located between the first and second portions, the third portion configured to provide relative movement between the first mounting bracket portion and the second mounting bracket portion over a range of flexibility without breaking.

2. The bracket as claimed in claim 1, wherein the first portion comprises:
a base; and
at least one leg extending from the base and configured to engage a bottom portion of a vehicle window panel.

3. The bracket as claimed in claim 1, wherein the first portion comprises:
a base; and
a pair of spaced legs extending from the base and forming a substantially U-shaped channel configured to engage a bottom portion of a vehicle window panel.

4. The bracket as claimed in claim 1, wherein the first portion is substantially rigid.

5. The bracket as claimed in claim 1, wherein the mounting bracket is non-frangible over a range of flexibility having a deflection angle in the range of up to ±45°.

6. The bracket as claimed in claim 1, wherein the mounting bracket is non-frangible over a range of flexibility having a deflection angle in the range of up to±10°.

7. The bracket as claimed in claim 1, wherein the first portion comprises plastic.

8. The bracket as claimed in claim 1, wherein the second portion includes at least one engagement element configured to engage a vehicle regulator system.

9. The bracket as claimed in claim 8, wherein the engagement element includes a hole configured to receive a retaining member.

10. The bracket as claimed in claim 1, wherein the third portion is made of a different material than the first and second portions.

11. The bracket as claimed in claim 1, wherein the third portion is made of the same material as the first and second portions.

12. The bracket as claimed in claim 1, wherein the first portion comprises a first keyway, the second portion comprises a second keyway, and the third portion is configured to engage the first and second keyways to connect the first portion to the second portion.

13. The bracket as claimed in claim 1, wherein the third portion comprises a flexible member having a thickness less than a thickness of the first and second portions.

14. The bracket as claimed in claim 13, wherein the flexible member defines side channels and a flexible material is deposited in the side channels.

15. The bracket as claimed in claim 1, wherein the third portion includes a longitudinal slot extending at least partly therethrough.

16. The bracket as claimed in claim 13, wherein the flexible member includes one or more longitudinal grooves formed therein.

17. The bracket as claimed in claim 1, wherein the third portion is made of a flexible material.

18. The bracket as claimed in claim 1, wherein the third portion comprises one or more connectors.

19. The bracket as claimed in claim 18, wherein the connectors are ball connectors comprising spaced balls connected by a rigid pin, with the balls configured to engage sockets in the first and second portions.

20. The bracket as claimed in claim 1, wherein the third portion provides the mounting bracket with side-to-side flexibility, longitudinal flexibility, and torsional flexibility.

21. A vehicle window assembly, comprising:
a window panel;
a regulator system configured to raise and lower the window panel; and
at least one flexible mounting bracket as claimed in claim 1 connecting the window panel to the regulator system.

22. The assembly as claimed in claim 21, wherein the window panel is a laminated window panel.

23. A vehicle window assembly, comprising:
a laminated window panel;
a regulator system configured to raise and lower the window panel; and
at least one flexible mounting bracket connecting the window panel to the regulator system, wherein. the flexible mounting bracket comprises:
a substantially rigid first portion comprising a base and a pair of spaced legs defining a substantially U-shaped channel, the first portion configured to engage the window panel;
a substantially rigid second portion having an engagement element configured to engage an attachment element of the regulator system to connect the bracket to the regulator system; and
a third portion located between the first and second portions, the third portion configured such that the first portion is non-frangibly movable relative to the second portion over a range of flexibility having a deflection angle in the range of up to ±45°.

24. A flexible mounting bracket, comprising:
a first mounting bracket portion configured to engage a panel;
a second mounting bracket portion configured to engage a regulator system to move the panel; and
a third mounting bracket portion located between and connecting the first and second portions, the third portion configured to provide relative movement between the first and second portions without breaking.

25. A method of attaching a vehicle window panel to a window regulator system, comprising:
attaching at least one flexible mounting bracket to a window panel; and
attaching the at least one mounting bracket to a vehicle regulator system by flexing the mounting bracket to align an engagement element on the bracket with an attachment element on the regulator system.
